(19) United States
(12) Patent Application Publication
(10) Pub. No.: US 2006/0178920 A1
(43) Pub. Date: Aug. 10, 2006

(54) Processing and creation of strategy information

(76) Inventor: Emmerentia Muell, Beccar (AR)

Correspondence Address: FISH & RICHARDSON P.C., P.O. BOX 1022, MINNEAPOLIS, MN, 55440-1022, US

(21) Appl. No.: 11/050,744

(22) Filed: Feb. 7, 2005

(51) Int. Cl. G06F 9/46

(52) U.S. Cl. 705/8

(57) ABSTRACT

A software-based tool that is described may assist an organization with formulating and implementing a corporate strategy and producing a blueprint of the corporation's strategy that can be monitored and adapted. The tool allows a user to enter a strategy for an organization, to analyze the strategy in two separate and independent manners producing two sets of categories, and to enter a set of sub-strategies including a different sub-strategy for achieving each combination of the two sets of categories. The tool may be used in conjunction with a process of meeting with management at successively more detailed levels of a corporate structure to formulate and apply the strategy at each level of the corporation's internal structure. Responsible entities and quantifiable measures may be identified for monitoring the corporation's performance in implementing the strategy, including a tri-partite measure of cost, time, and quality.

### TECHNICAL FIELD

This disclosure relates to the processing and creation of strategy information.

### BACKGROUND

Many algorithms exist for formulating strategy information, particularly the information in a corporate strategy. In typical implementations, the management of a corporate entity, such as a corporation, determines a corporate mission and vision, and enumerates various goals for carrying out the mission and achieving the vision. The corporation often finds it difficult, however, to either accomplish the goals, or even if the goals are accomplished the corporation may find it difficult to carry out the mission and achieve the vision. In such situations, the corporation is finding it difficult to Make Strategy Happen™.

### SUMMARY

Implementations are described that formulate and implement corporate strategy in a manner that allows the corporation to Make Strategy Happen™. In one implementation, corporate strategy is formulated using workshops that meet separately with different levels of management. The workshops are implemented with management at successively more detailed levels of the corporate structure. In this manner, a corporate strategy is formulated that involves representatives of the whole corporation and that applies the strategy to each level of the corporation's internal structure, all the way down to a level of granularity that describes the actual work product or a worker's actions. At each level of this sequential, and possibly, iterative, process, the goals are formulated in response to the stated strategy goals at each of the previous levels, ensuring that the formulated strategy is integrated, cohesive, and interdependent. Further, at each level of the strategy, quantifiable measures and responsible entities are identified for monitoring the corporation's performance in implementing the strategy. For the more granular levels a tripartite measure including measures for cost, time, and quality is used to specify and monitor the work product being produced. The result is a strategy blueprint for the corporation.

The implementation of the above-formulated corporate strategy may be facilitated by a software tool that guides a user through the process of entering the strategy information that was determined in the workshops, and that presents the strategy information in an organized display. The software tool also allows the entry of actual performance data, and then processes and presents the performance data in a manner allowing comparisons and evaluations of the corporation's progress in implementing the strategy. The software tool further allows an authorized user to modify the strategy information in real-time, based on the performance data or other reasons. By making real-time modifications, the corporation's strategy remains an effective guide for management in running the corporation and making effective decisions, allowing management to anticipate strategy implementation exceptions (for example, inefficiencies or problems) and identify the causes.

In this manner, both the formulation and the implementation of a corporate strategy are performed in manners that provide both transparency and accountability. Transparency is provided in the formulation process by involving representatives of the whole company, and is provided in the implementation process by providing a visual display of the strategy in the software tool and by making the visual display available to all permitted users to view and possibly change. Accountability is provided in the formulation process by designating responsible entities and quantifiable performance measures at one or more of each of the various levels of the strategy, and is provided in the implementation process by making the responsible entities and the quantifiable measures readily accessible in the software tool.

According to a general aspect, a software-based tool for assisting an organization with corporate strategy includes a first portion instructing a user to enter a strategy for a particular business function of an organization. The tool includes a second portion instructing the user to analyze the strategy in a first manner to produce a first set of categories related to achieving the strategy. The tool includes a third portion instructing the user to analyze the strategy in a second manner to produce a second set of categories related to achieving the strategy, the second set being independent of the first set. The tool also includes a fourth portion instructing the user to enter a set of sub-strategies including a different sub-strategy for each combination of categories in the first and second sets, each of the sub-strategies related to achieving a particular one of the combination of categories.

Implementations may have one or more of the following features. For example, the first set of categories may include qualitative goals and the second set of categories may include tasks. The tool may include a fifth portion instructing the user to enter (i) an identification of multiple business units of the organization, and (ii) a set of business functions of the organization, the set of business functions including core functions for each business unit and shared functions across business units, and the set of business functions including the particular business function. The fifth portion may instruct the user to enter an identification of all business units of the organization. The tool may include a portion instructing the user to enter a set of core requirements for the organization, the core requirements including one or more core obligations and one or more core objectives.

The tool may include the following three additional portions. First, a portion instructing the user to enter one or more steps for implementing each sub-strategy, and measurable standards of performance for each step, the measurable standards including standards for a cost incurred to perform the step, a time incurred to perform the step, and a quality of performance of the step. Second, a portion for comparing the measurable standards against actual performance data for each step and evaluating the performance data based on results of the comparing. Third, a portion for presenting results of the evaluating to the user, along with presenting the strategy information to the user.

In addition to the above three additional portions, the tool may include another portion instructing the user to enter a responsible party for each of the steps. The additional “portion for presenting results” may then be configured to present the responsible party for each step for which performance data is evaluated and for a corporate level of the strategy, a functional level of the strategy, and an operational level of the strategy. One or more of the first portion, the fourth portion, and the additional “portion for instructing the user” may be configured to allow the user to change all or part of the entered information after being presented the results of the evaluating.

According to another general aspect, formulating corporate strategy for an organization includes determining a strategy for a particular business function of an organization. Formulating corporate strategy also includes analyzing the strategy in a first manner to produce a first set of categories related to achieving the strategy. Formulating corporate strategy also includes analyzing the strategy in a second manner to produce a second set of categories related to achieving the strategy, the second set being independent of the first set. Formulating corporate strategy further includes determining a set of sub-strategies including a different sub-strategy for each combination of categories in the first and second sets, each of the sub-strategies related to achieving a particular one of the combination of categories.

Implementations may include one or more of the following features. For example, the first set of categories may include qualitative goals and the second set of categories may include tasks. Formulating corporate strategy may further include identifying multiple business units of the organization, and identifying a set of business functions of the organization, the set of business functions including (i) core functions for each business unit and (ii) shared functions across business units, and the set of business functions including the particular business function. Identifying multiple business units may include identifying all business units of the organization. Formulating corporate strategy may further include determining a set of core requirements for the organization, the core requirements including one or more core obligations and one or more core objectives.

Formulating corporate strategy may further include determining one or more steps for implementing each sub-strategy, and determining measurable standards of performance for each step, the measurable standards including standards for a cost incurred to perform the step, a time incurred to perform the step, and a quality of performance of the step. Formulating corporate strategy may further include comparing the measurable standards against actual performance data for each step, and evaluating the performance data based on results of the comparing. Formulating corporate strategy may further include presenting, to the user, results of the evaluating and strategy information including one or more of the strategy, the first set of categories, the second set of categories, and the set of sub-strategies.

Formulating corporate strategy may further include determining measurable standards of performance for the strategy, the first set of categories, the second set of categories, and the set of sub-strategies. Formulating corporate strategy may further include determining a responsible party for each of the steps, and presenting the strategy information may then include presenting the responsible party for each step for which performance data is evaluated. Formulating corporate strategy may further include the user changing one or more of the strategy, the first set of categories, the second set of categories, and the set of sub-strategies after the user is presented the results of the evaluating.

According to another general aspect, formulating strategy for a corporation having multiple business units includes using a strategy team to work with multiple layers of management to develop a strategy. The strategy team works with top level management of a corporation to determine (i) core requirements including core obligations and core objectives, and (ii) multiple business units of the corporation. The strategy team works with functional level management to determine (i) business functions including core functions for each business unit, and shared functions across multiple business units, (ii) missions for each business function, and (iii) functional strategies for achieving each of the core requirements within each business function. The strategy team works with operational level management to determine critical enablers, tasks, and operational strategies for each functional strategy. Determining the critical enablers for any given functional strategy includes analyzing the given functional strategy in a first manner to produce the critical enablers related to achieving the given functional strategy. Determining the tasks for any given functional strategy includes analyzing the given functional strategy in a second manner to produce the tasks related to achieving the given functional strategy. The tasks and critical enablers related to achieving the given functional strategy are independent of each other. The operational strategies for any given functional strategy include a different operational strategy for each combination of critical enabler and task related to achieving the given functional strategy, and each of the different operational strategies is related to achieving a particular one of the critical enablers and a particular one of the tasks that form the combination.

Implementations may include one or more of the following features. For example, the strategy team may work with operational level management to determine steps for implementing each operational strategy, and to determine measurable standards for cost, quality, and time for each step. The strategy team may assign a responsible entity for each step. The strategy team may work with top level management (i) to perform an analysis of the corporation's strengths, weaknesses, opportunities, and threats (“SWOT”), and (ii) to apply results of the SWOT analysis to determine strategic direction and strategic objectives. Working with top level management to determine the core requirements may include determining the core requirements based on the strategic direction and the strategic objectives. Formulating strategy for the corporation may include using a software tool to capture information.

The details of one or more implementations are set forth in the accompanying drawings and the description below. Other features will be apparent from the description and drawings, and from the claims.

### DESCRIPTION OF DRAWINGS

FIG. 1 is a diagram showing a first depiction and a second depiction of a strategy formulation process.

FIG. 2A is a diagram showing a third depiction of a strategy formulation process.

FIG. 2B depicts the XUY concept and an example.

FIG. 2C is a series of XUY matrices at successive levels of an organization.

FIGS. 3A-C are a flowchart of an implementation of the strategy formulation of FIG. 2.

FIGS. 4A-M are a series of screen shots from a software tool for formulating and implementing corporate strategy according to an implementation of the process of FIGS. 3A-C.

FIG. 5A is a matrix of functional strategies for a corporation.

FIG. 5B is a matrix of operational strategies for a corporation.

FIGS. 6A-B are two screen shots from a front-end of the software tool of FIGS. 4A-M depicting a presentation of information entered by a user.

FIGS. 7A-C are three screen shots from the front-end of the software tool of FIGS. 4A-M depicting a presentation of performance information.

### DETAILED DESCRIPTION

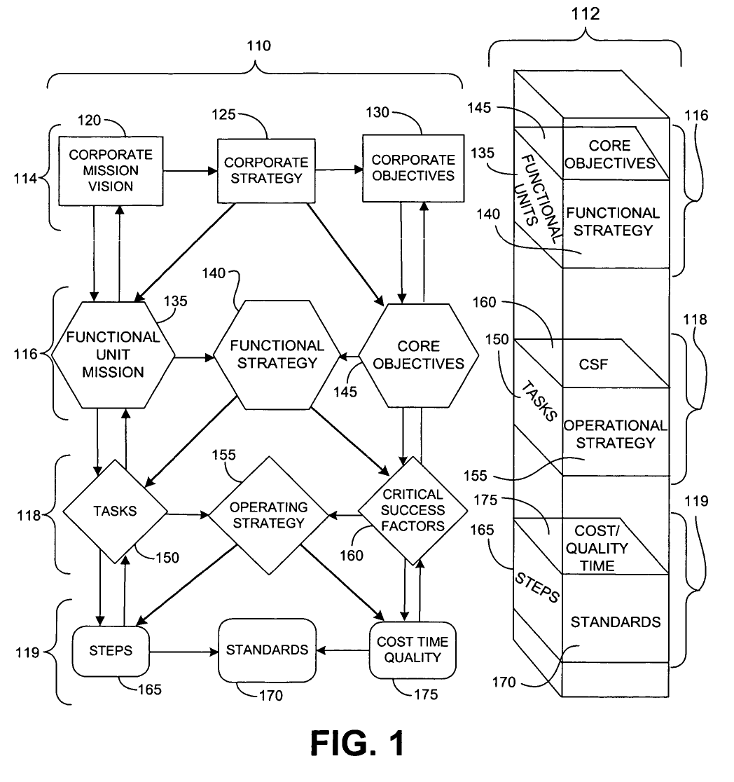

Referring to FIG. 1, a strategy formulation process for a corporation is shown using both a layout 110 and a pillar 112. Pillar 112 is a generalized version of layout 110, as explained below. Layout 110 includes a corporate strategy level 114, and both layout 110 and pillar 112 include a functional strategy level 116, an operational strategy level 118, and a more granular strategy level 119. A corporation refers to a corporate entity, that is, an entity that includes multiple individuals. Examples of corporations include a for-profit company, a not-for-profit company, a university or other school, a consortium, a sports team, a professional organization, and a sub-division of such a corporation.

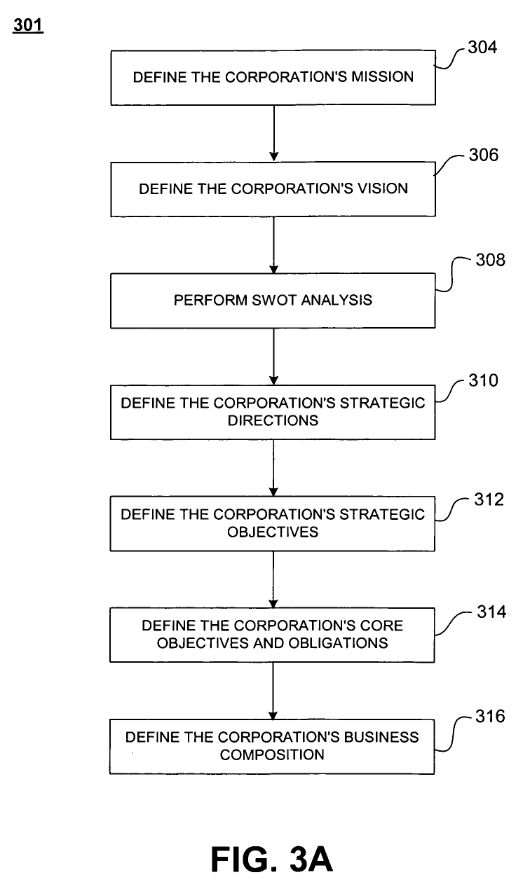

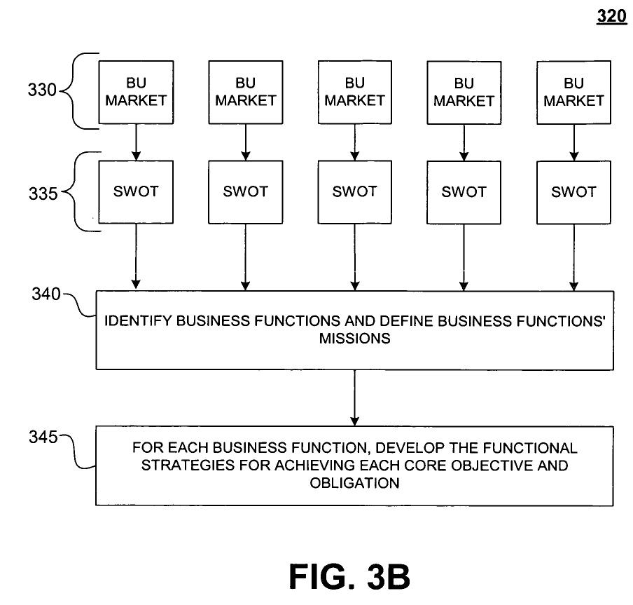

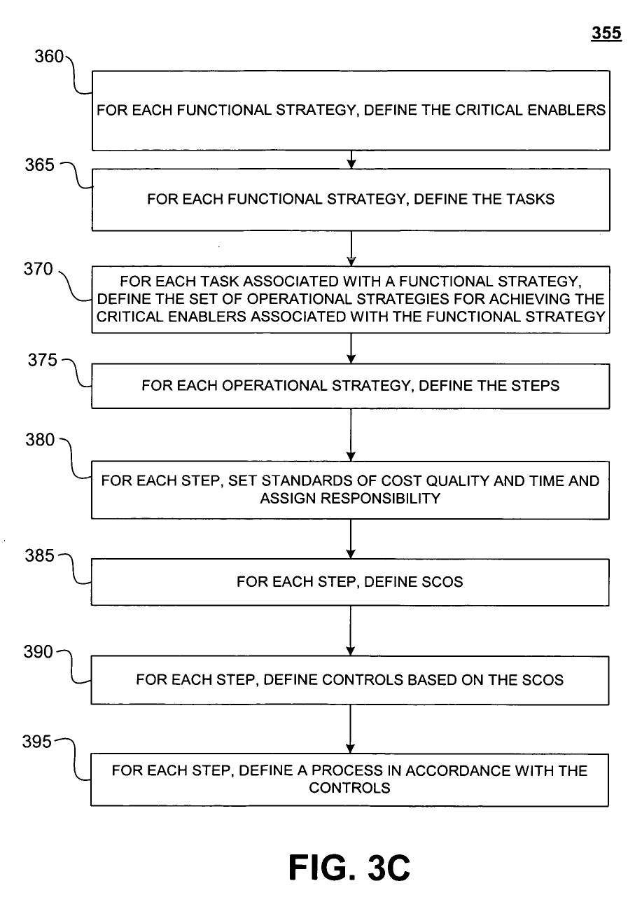

Corporate strategy level 114 refers to the level of strategy formulation typically involving top-level management and concerned with formulating a strategy for the corporation as a whole. Corporate strategy level 114 includes a corporate mission and vision block 120, a corporate strategy block 125, and a corporate objectives block 130, with blocks 120, 125, and 130 being interconnected with arrows as indicated. The functions of blocks 120, 125, and 130 are described in the discussion of FIGS. 3A-C and subsequent figures.

Functional strategy level 116 refers to the level of strategy formulation typically associated with a functional unit of a corporation, such as marketing, finance, and production. Functional strategy level 116 includes a functional unit mission block 135, a functional strategy block 140, and a core objectives block 145. Blocks 135, 140, and 145 are interconnected with arrows in layout 110, and are adjacent one another forming three faces of a cube in pillar 112. Further, blocks 135, 140, and 145 are connected as shown in layout 110 to blocks 120, 125, and 130 of level 114. The functions of blocks 135, 140, and 145 are described in the discussion of FIGS. 3A-C and subsequent figures.

The adjacency of blocks, such as blocks 135, 140, and 145, in pillar 112 indicates a generality of communication between those blocks and an interdependency between those blocks. In various implementations, the adjacency indicates a matrix logic, such as, for example, the matrix logic described below, in which variables are mixed to form strategies. The remaining faces (not shown) of the cubes are not described.

Operational strategy level 118 refers to the level of strategy formulation typically associated with an operational task being performed within a functional unit of a corporation. Operational strategy level 118 includes a tasks block 150, an operating strategy block 155, and a critical success factors block 160. Blocks 150, 155, and 160 are interconnected with arrows in layout 110, and are adjacent one another forming three faces of a cube in pillar 112. Further, blocks 150, 155, and 160 are connected as shown in layout 110 to blocks 135, 140, and 145 of level 116. The functions of blocks 150, 155, and 160 are described in the discussion of FIGS. 3A-C and subsequent figures.

The more granular strategy level 119 refers to the level of strategy formulation typically associated with one or more steps for carrying out an operational task within a functional unit of a corporation. Level 119 is intended to identify, for example, the minimal unit of strategic expression relevant for accomplishing a company's strategic goals. Level 119 includes a steps block 165, a standards block 170, and a cost/quality/time block 175. Blocks 165, 170, and 175 are interconnected with arrows in layout 110, and are adjacent one another forming three faces of a cube in pillar 112. Further, blocks 165, 170, and 175 are connected as shown in layout 110 to blocks 150, 155, and 160 of level 118. The functions of blocks 165, 170, and 175 are described in the discussion of FIGS. 3A-C and subsequent figures.

The different levels 116, 118, and 119 in pillar 112 are shown as being separated, but communication between levels 116, 118, and 119 is intended. The arrows shown throughout layout 110 are an example, and implementations of layout 110 may provide for communication paths other than those shown by the arrows in FIG. 1. Indeed, layout 110, as well as pillar 112, may provide for complete communication between the blocks depicted, including communication between blocks separated by an intervening level.

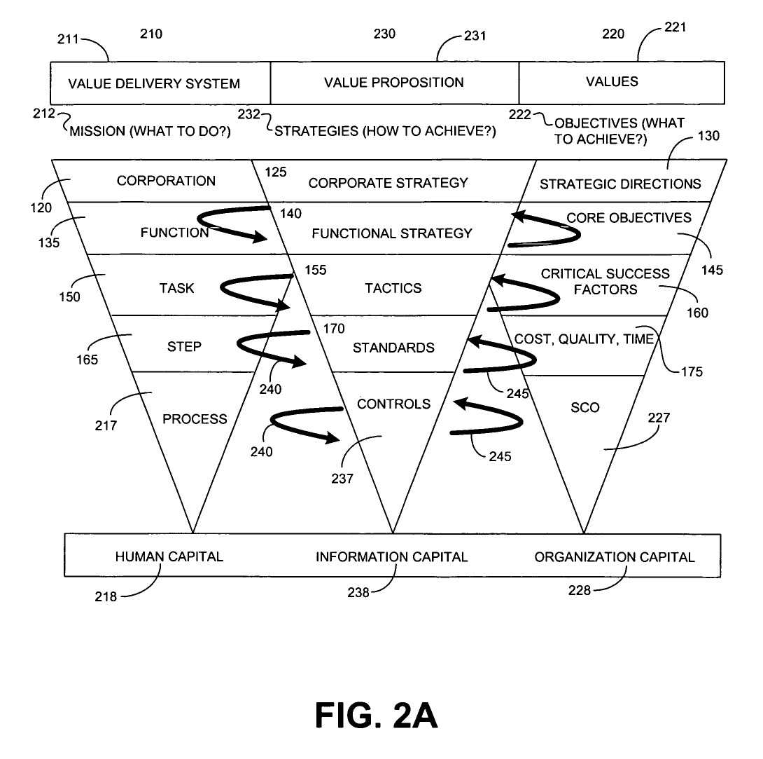

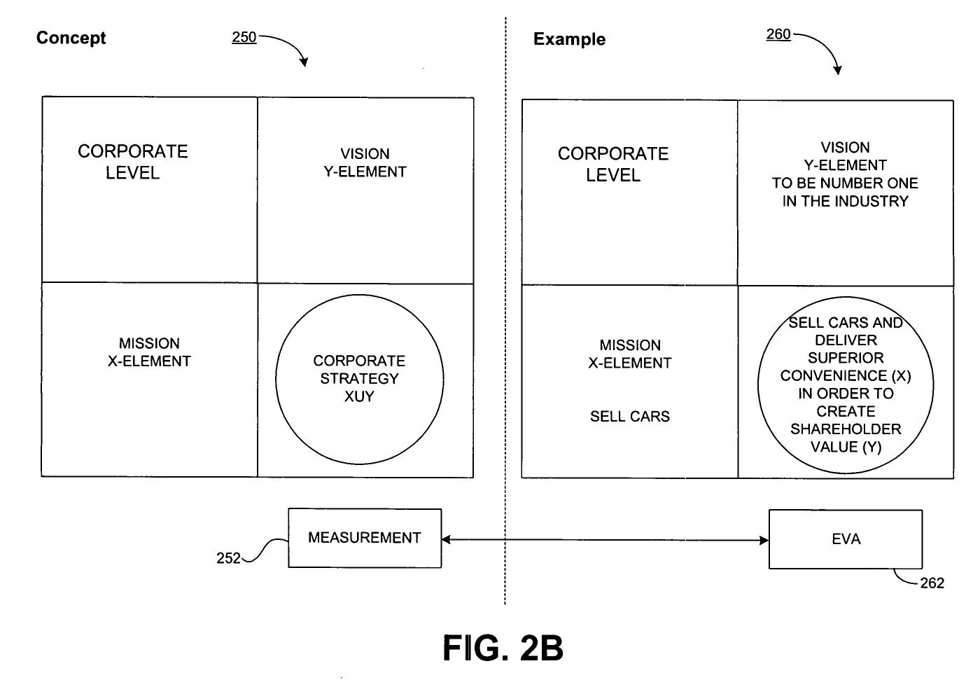

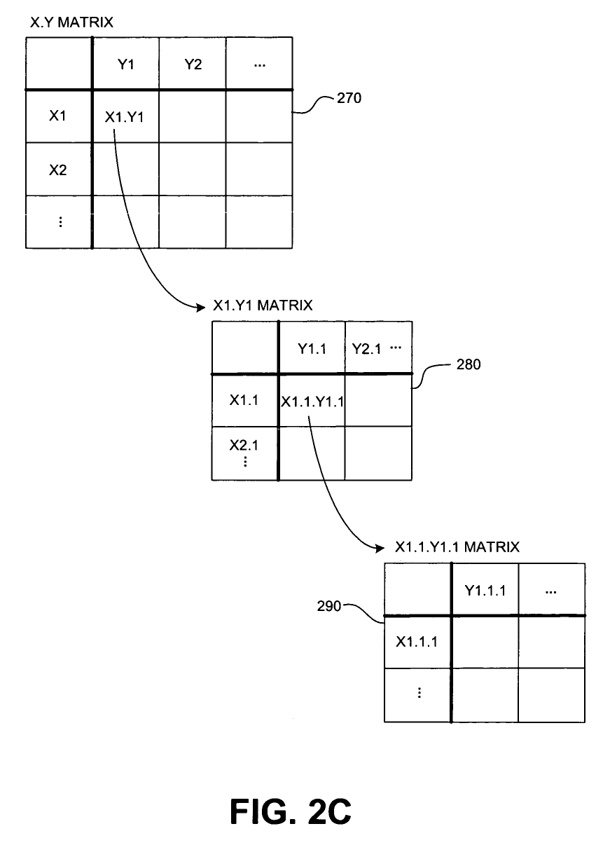

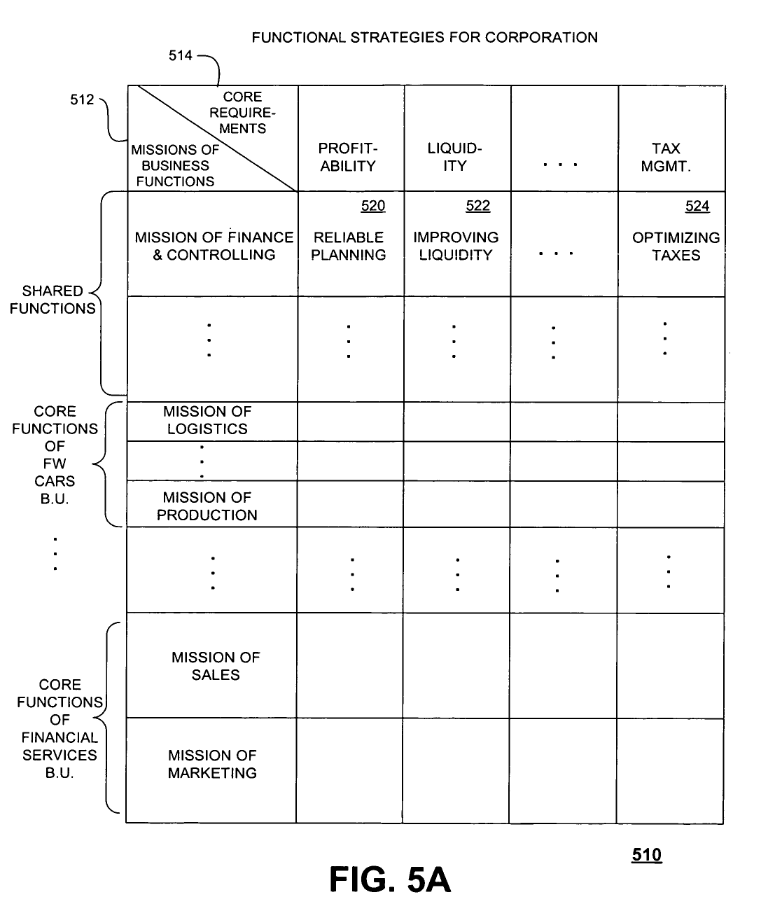

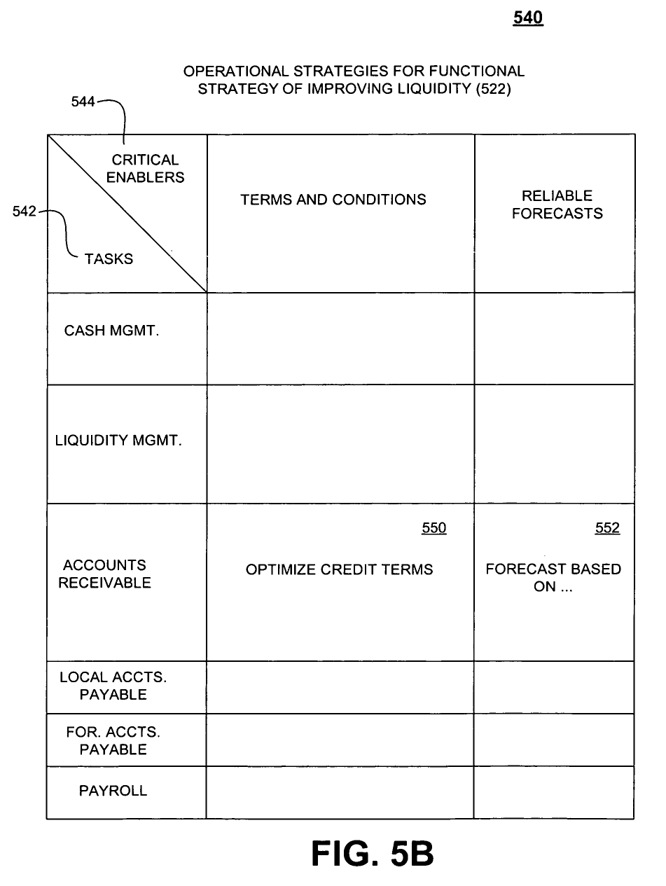

The arrows shown in layout 110 may provide an effective delegation process for formulating strategies, as explained for example with respect to FIG. 2 below. Each manager, at either the corporate level, the functional level, or the operational level may define strategy for that level and set the conditions on the level below for allowing the manager at that level (the level below) to effectively formulate strategy at that level given the defined framework. The conditions may be set, for example, by defining the variables of each axis of the matrices in FIG. 5A below. This process may continue all the way down to, and including, the operational level.

Referring to FIG. 2A, a spiral methodology 200 is shown that provides an alternate mechanism for thinking about the process of formulating corporate strategy. Methodology 200 includes the information and structure from FIG. 1 and organizes that information in three inverted pyramids 210, 220, and 230 that flow from general information to more specific information as one moves from the top to the bottom in any given pyramid 210, 220, or 230. Arrows 240 indicate a spiraling down of information, and arrows 245 indicate a spiraling up of information, demonstrating that information may flow between any of the elements depicted. Elements in methodology 200 that are common with elements in FIG. 1 are not described further. However, methodology 200 includes additional elements not found in FIG. 1, and these are now described.

Inverted pyramid 210 is concerned principally with corporate mission and the missions of various narrower organizational units within a corporation. This concern is indicated by a title 211 of “Value Delivery System,” a label 212 of “Mission (what to do?),” and a categorization 218 of “Human Capital.” Inverted pyramid 210 further includes a series of organizational unit blocks including a process block 217 representing a more granular strategy block than steps block 165. The function of process block 217 is described in the discussion of FIGS. 3A-C and subsequent figures.

Inverted pyramid 220 is concerned principally with corporate values and the objectives of various narrower organizational units within a corporation. This concern is indicated by a title 221 of “Values,” a label 222 of “Objectives (what to achieve?),” and a categorization 228 of “Organization Capital.” Inverted pyramid 220 further includes a series of organizational unit blocks including a step-control objectives (“SCO”) block 227 representing a more granular strategy block than cost/quality/time block 175. The function of SCO block 227 is described in the discussion of FIGS. 3A-C and subsequent figures.

Inverted pyramid 230 is concerned principally with corporate strategy and the strategies of various narrower organizational units within a corporation. This concern is indicated by a title 231 of “Value proposition,” a label 232 of “Strategies (how to achieve?),” and a categorization 238 of “Information Capital.” Inverted pyramid 230 further includes a series of organizational unit blocks including a controls block 237 representing a more granular strategy block than standards block 170. The function of controls block 237 is described in the discussion of FIGS. 3A-C and subsequent figures.

Various implementations described are based on applied mathematics and introduce a new approach to strategy that interweaves the three most important dimensions of strategic thinking, which are “What to do,” “What to achieve,” and “How to achieve.” The three dimensions of strategic thinking may be repeated on every level of the organization but with a narrowing scope of responsibility and time relevance. These three dimensions which decline in scope and time can be represented in the inverted pyramids 210, 220, and 230. Spiral methodology 200 is three-tiered and spirals down the strategy continuum among the inverted pyramids 210, 220, and 230 to integrate the different levels of the organization. Methodology 200 incorporates mathematical principles (for example, matrices and Cartesian mathematics) that support the logical framework of methodology 200. Inverted pyramid 210 represents “What to do” (X-element), inverted pyramid 220 represents “What do achieve” (Y-element), and inverted pyramid 230 represents “How to get there” (XUY), where XUY represents the union of X and Y.

The highest level of inverted pyramids 210, 220, and 230 represents the leader who thinks broad and long-term, and is responsible for the full scope of the organization. This leader will typically articulate the following:

1) Determine the mission and scope of the entity (What do we do? Who are we?). X-element.

2) Determine the vision (What do we want to achieve?). Y-element.

3) Determine the value proposition or strategy (How do we get there?). XUY.

Inverted pyramid 230, which represents strategies (XUY), serves as a connecting element, and bridges the “What to do” with the “What to achieve.” The strategy is defined within the scope of the corporation and aligned with the vision.

In order for the leader to execute the strategy (XUY), the leader sets the framework for the next level of management in the hierarchy. The framework can be explained through the two axes of a matrix: the X axis, “What to do”; and the Y axis, “What to achieve.”

Regarding the X-axis (“What to do?”), the leader breaks the business down into manageable units. These manageable units are the next level in the hierarchy, and are referred to as functions. By doing this, the leader breaks the mission of the corporation (X-element) into sub-elements that can be called Function I (X1), Function 2 (X2), Function 3 (X3), Function 4 (X4), etc. The sum of the functions refers back to the X element in the corporate strategy. Once functions have been defined, the leader assigns responsibilities.

Regarding the Y-axis (“What to achieve?”), in this framework, the leader not only determines “What to do,” but also determines “What to achieve.” Let us suppose that the Y element in the corporate strategy represents shareholder value. Shareholder value (Y) can be broken down into four core objectives, for example, profitability (Y1), liquidity (Y2), growth (Y3), and customer loyalty (Y4). These variables correlate to influence shareholder value. Once objectives have been defined, the leader defines their respective measurements and targets.

Regarding the union XUY (“How to achieve?”), although the leader sets the framework, but the leader may delegate the formulation of“How to achieve” to the next level of the hierarchy—the functional level. The functional leader then determines the functional strategy, which is the bridge between “What to do” and “What to achieve.” This combination has been expressed above as XUY, a union of X and Y. Accordingly, the functional strategies may be conceived of as the combination between the functions (X) and the core objectives (Y), and as covering the surface area of that combination.

Referring to FIG. 2B, the XUY concept is shown in a matrix 250 indicating a union, or other combination, of mission (X) and vision (Y) resulting in a corporate strategy (XUY). Note that an XLY strategy may refer to either a corporate strategy or a functional strategy. In the highest level of strategy formulation, the XUY strategy is a corporate strategy and refers to the corporate value proposition that exists over all of the business functions. The corporate strategy corresponds to the corporate mission (X) and the corporate vision (Y). As further explained below, functional strategies generally correspond to the alignment of the mission of a particular business function (X) and the core objectives of the company (Y). A measurement 252 is also provided for the strategy (XUY). FIG. 2B also provides an example that includes a matrix 260 with a mission (X) of selling cars, a vision (Y) of being number one in the industry, and a resulting strategy (XUY) of selling cars and delivering superior convenience in order to create shareholder value. A measurement 262 of EVA (Economic Value Added) is also provided for measuring the performance of the resulting strategy.

The same logic may be followed all the way down to the most operational level of the methodology 200. Referring to FIG. 2C, a matrix 270 is formed from rows for the X value, and columns for the Y value. The X values (or X axis) may represent tasks X1, X2, etc., and the Y values (or Y axis) may represent specific critical success factors Y1, Y2, etc. Matrix 270 combines the tasks and critical success factors to form the XUY strategies for each combination, such as, for example, X1.Y1. These strategies may be broken down, for example, into sub-tasks X1.1, X2.1, etc. and sub-(critical success factors) Y1.1, Y2.1, etc. which are combined to form sub-strategies (for example, X1.1.Y1.1), as depicted in a matrix 280. A matrix 290 depicts a further breakdown, which is performed for the sub-strategy X1.1.Y1.1. This breakdown process may continue, for example, down to steps that are carried out to achieve cost, quality, and time improvements.

In the above implementation, methodology 200 functions by constantly combining variables X and Y, at all levels of the company's hierarchy in order to generate a number of value propositions at each level (functional strategies, operational strategies, etc.), developing a spiral effect after which the methodology was named. Through this methodology, a company may build a strategic blueprint by structuring a strategic planning process. This supports management through built-in steering tools and it provides a structure to organize and manage knowledge.

Referring to FIGS. 3A-C, a process 300 for formulating corporate strategy is presented that is based on spiral methodology 200. Process 300 may be implemented using a series of workshops with representatives of the corporation. More specifically, such workshops may be facilitated by a strategy development team and the attendees, other than the strategy development team, may include various levels of management. Separate workshops may be held for different levels of management, such as top-level management, functional level management, and operational level management.

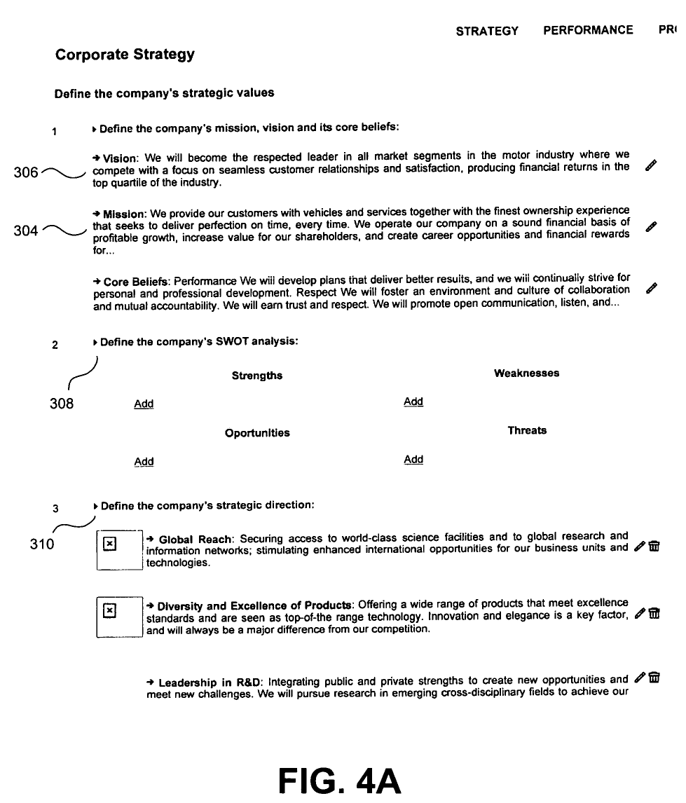

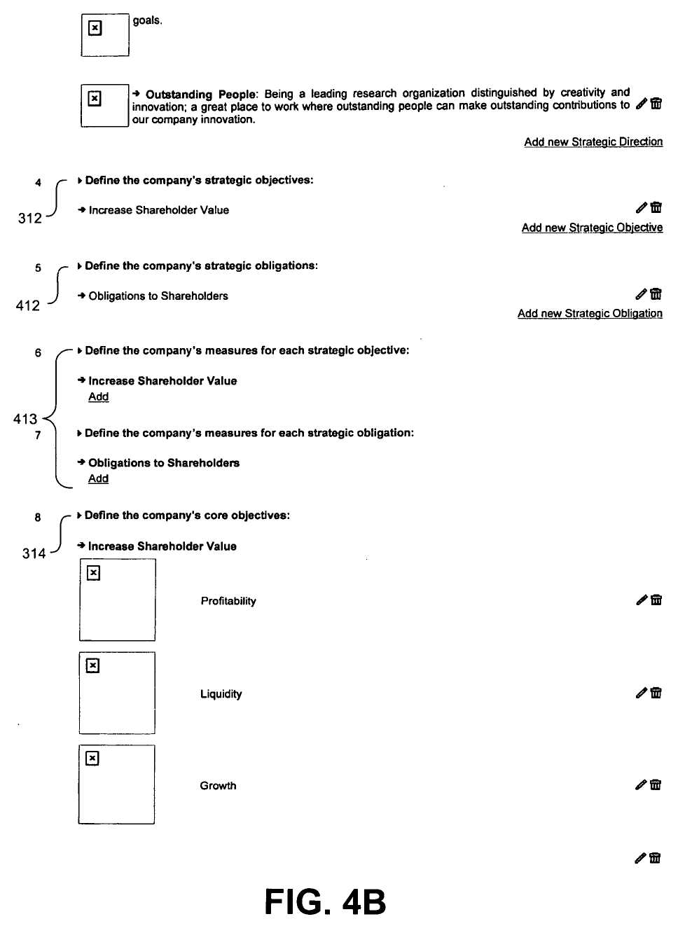

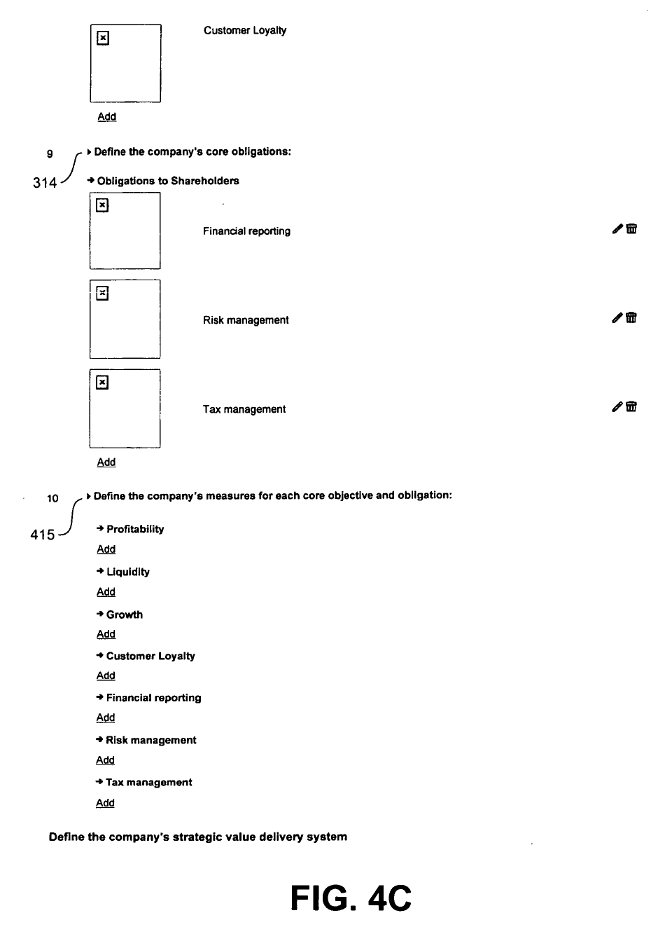

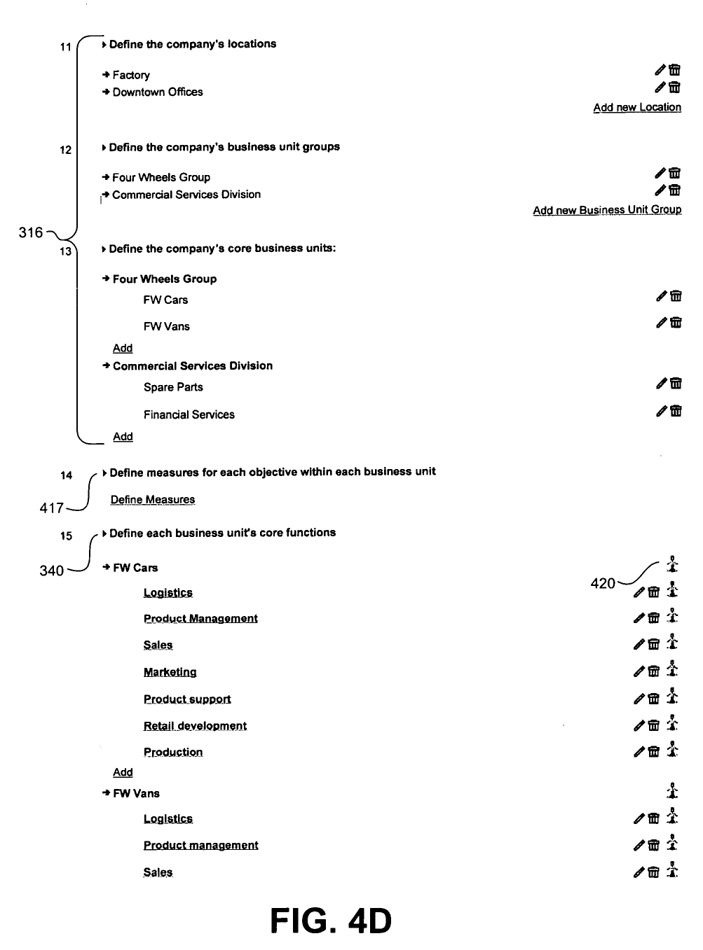

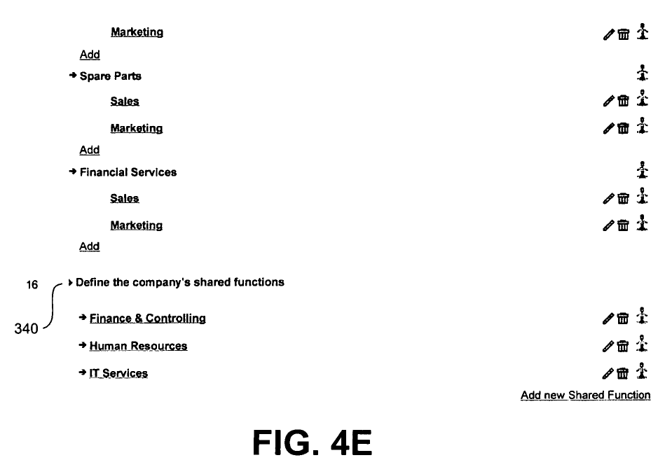

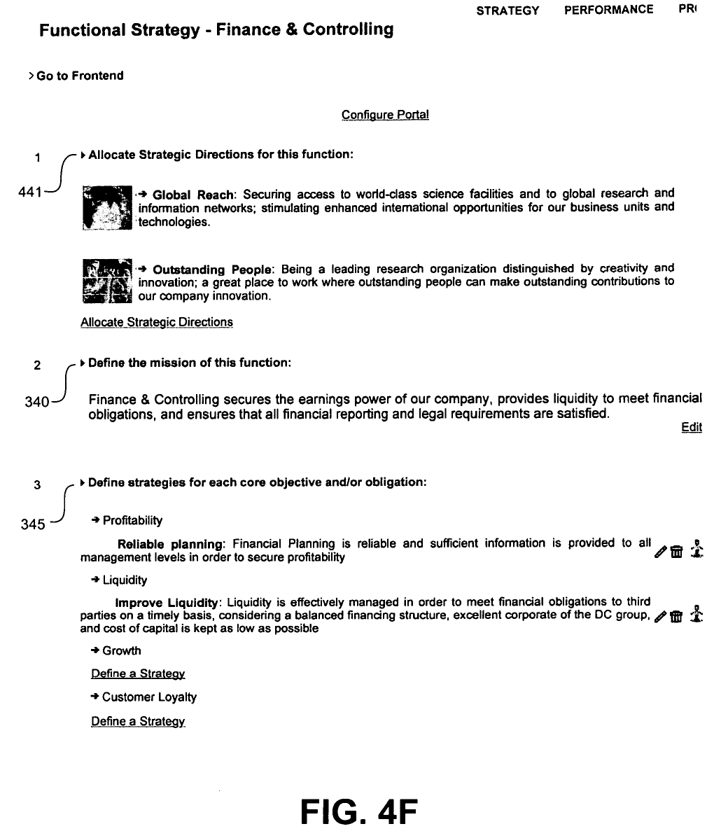

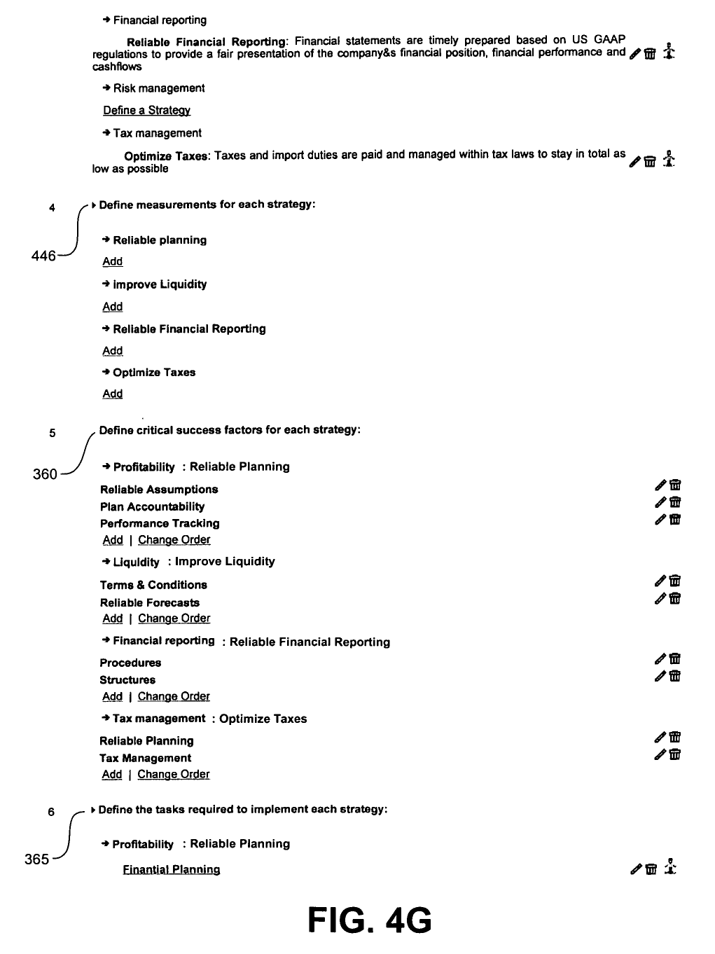

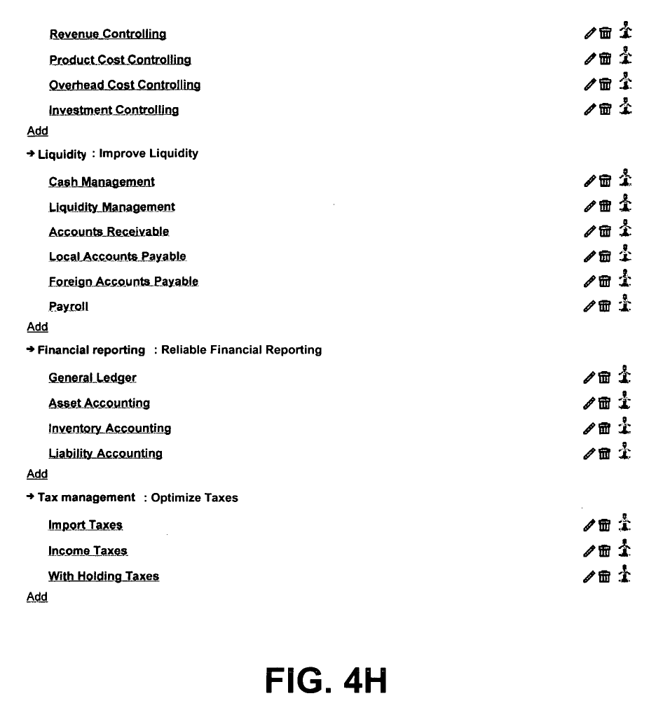

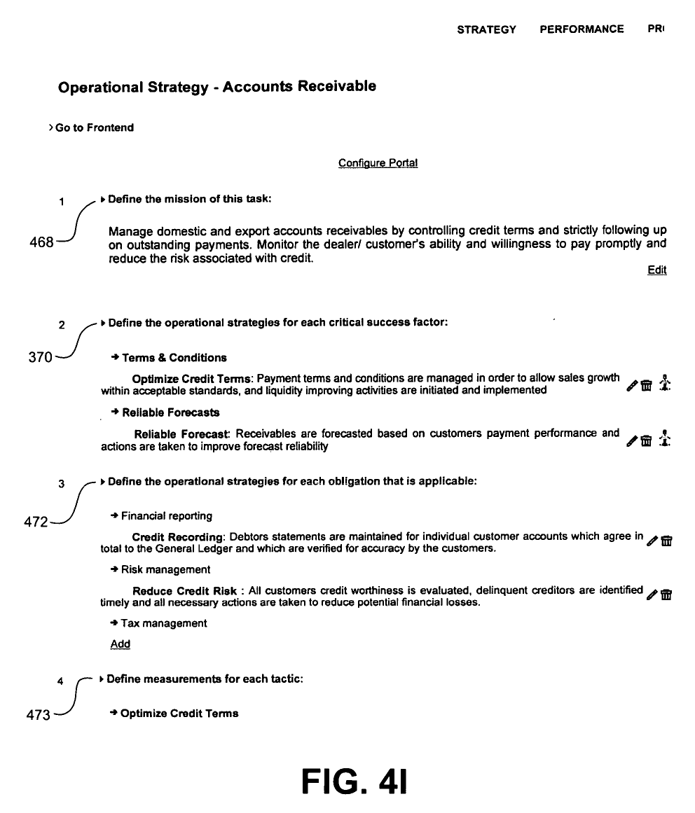

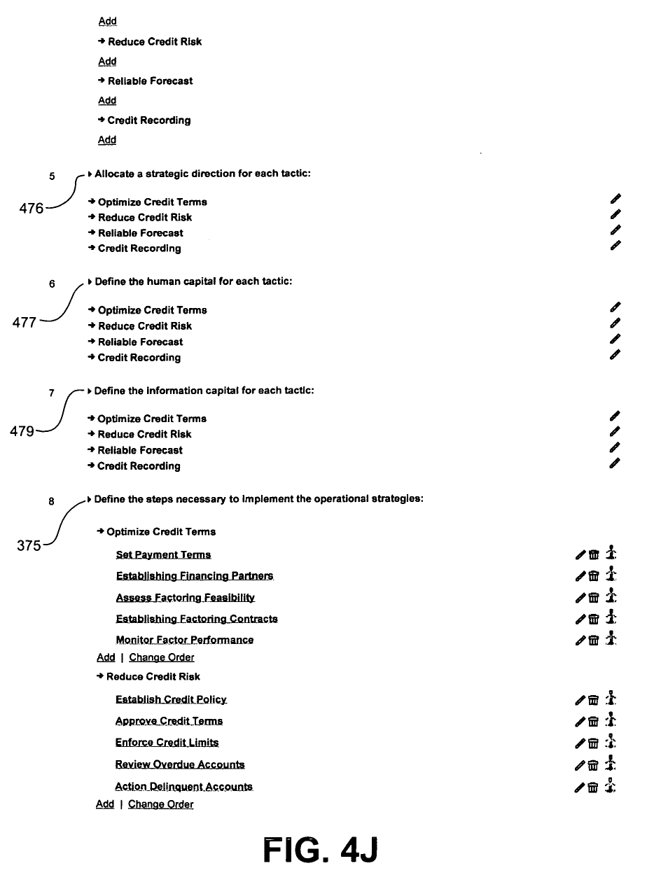

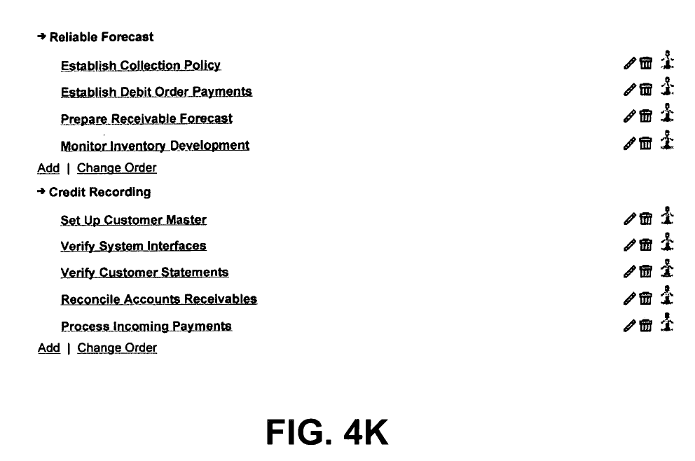

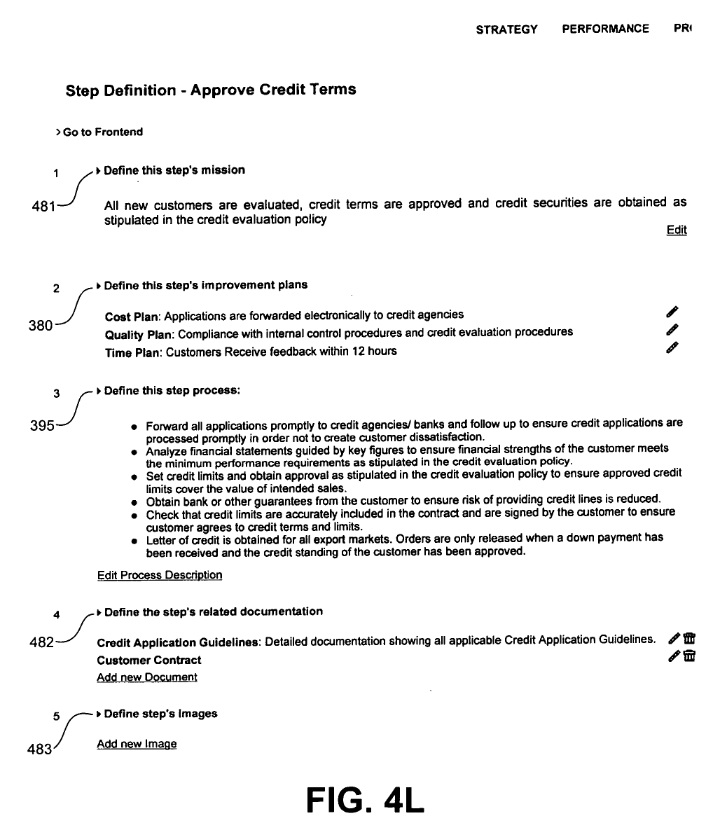

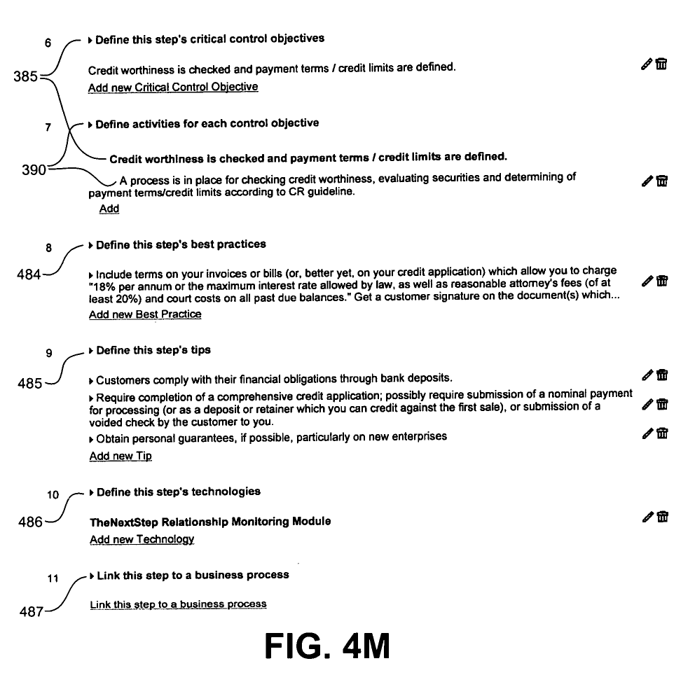

Referring also to FIGS. 4A-M, a series of screen shots from a software tool are shown that provide data from a specific implementation of process 300 for a for-profit company. The software tool allows data gathered during the strategy formulation process (for example, process 300) to be entered and presented in an organized and hierarchical manner, as shown in FIGS. 4A-M. The operations of process 300 are described below with reference to the specific implementation presented in the screen shots of FIGS. 4A-M.

Referring to FIGS. 3A and 4A, a sub-process 301 may be carried out in one or more workshops with top-level management. Sub-process 301 includes the familiar concepts of defining the corporation's mission (304; see also element 212 of FIG. 2) and vision (306, see also element 222 of FIG. 2). A corporation's mission typically relates to the corporation's scope and essence, while the corporation's vision typically relates to the corporation's future position and ambitions.

Sub-process 301 further includes performing an analysis of the corporation's strengths, weaknesses, opportunities, and threats (“SWOT”) (308), which is a strategic analysis of the corporation's current situation. Often, the corporation's strengths determine the corporation's opportunities, and the corporation's weaknesses determine the corporation's threats. The SWOT analysis is a tool that may enrich the process of formulating a corporate strategy. As such, the results of the SWOT analysis are typically used in formulating the rest of the corporation's strategy although the results are not necessarily directly applied to successive operations in sub-process 301.

Sub-process 301 continues by defining the corporation's strategic directions (310; see also element 130 in FIGS. 1 and 2), which may be conceived of as guidelines for thinking about the corporation's strategic objectives. Sub-process 301 continues by defining the corporation's objectives (312; see also element 130 in FIGS. 1 and 2), which may be conceived of as the ultimate goals for the corporation. As an example of a strategic direction and objective, referring to FIGS. 4A-B, a corporation's strategic direction may include (i) having a global reach, (ii) having products that are diverse and excellent, (iii) being a leader in research and development, and (iv) having outstanding people. The corporation's strategic objective may be to increase shareholder value, particularly for a for-profit corporation.

Implementations of process 300 also may define the corporation's strategic obligations (412), such as obligations to shareholders for a for-profit corporation. Further measures may be defined for one or more of the strategic objectives and obligations (413). Such measures may include, for example, stock price, revenue growth, operating profit, market share, new customers as a percent of sales, and compliance with various legal requirements.

Sub-process 301 continues by defining the corporation's core objectives and obligations (314; see also element 145 in FIG. 1 and 2), which are generally a breakdown of the corporation's strategic objective. The core objectives and core obligations are referred to collectively as the core requirements, and the core requirements are a decomposition of the corporate strategy and the corporation's strategic objective that reflects particular aspects of the corporate strategy and the corporation's strategic objective. Referring to FIGS. 4B-C, the corporation's core objectives may include profitability, liquidity, growth, and customer loyalty, and the corporation's core obligations may include financial reporting, risk management, and tax management. Again, a variety of standard or custom measures may be defined for one or more of the core objectives and core obligations (415).

Sub-process 301 also includes defining the corporation's business composition (316; see also element 120 in FIG. 1 and 2), typically resulting in a list of business units. The business composition may be defined, for example, by markets or products, and the definition may be based on the preceding analysis to arrive at a good strategic breakdown of the corporation's business composition. Referring to FIG. 4D, a list of business units may include (i) a four-wheel cars business unit, (ii) a four-wheel vans business unit, (iii) a spare parts business unit, and (iv) a financial services business unit. As shown in FIG. 4D, the operation of defining a corporation's business composition 316 also may include considering such aspects as the corporation's locations. Again, one or more measures also may be defined. In particular, for each business unit, measures may be identified for each of the core objectives and obligations (417).

Referring to FIG. 3B, a sub-process 320 may be carried out in one or more workshops with functional level management. Sub-process 320 begins with the result of operation 316 in which the corporation's business composition was defined, with the result being referred to as a list of business units 330, and a SWOT analysis is performed for each business unit (335). The SWOT analysis (335) allows the functional level managers to understand the business environment of each business unit and provides a basis for the further development of business strategy for each of these business units.

Sub-process 320 includes identifying the business functions of the corporation, which include core functions for each business unit, as well as shared functions that are shared across two or more of the business units (340; see also element 135 in FIGS. 1 and 2). Referring to FIGS. 4D-E, core functions may include functions such as logistics, product management, sales, marketing, product support, retail development, and production. Further, shared functions may include finance and controlling, human resources, and information technology (“IT”) services. Many of the same core functions may be performed by multiple business units, such as sales which is performed by each of the four business units. However, such functions may be “common” functions without being shared because, for example, each business unit may need its own personnel to perform that function.

FIG. 4D includes a “person” icon indicating that a responsible entity has been assigned. Assigning responsibility is discussed further with respect to operation 380 below.

Operation 340 also includes defining a mission for each of the identified business functions. Referring to FIG. 4F, a mission for the finance and controlling business function is shown. As with the core requirements discussed above, the set of missions, including one mission for each of the business functions, taken together are a decomposition of the overall corporate mission. As shown in FIG. 4F, implementations of sub-process 320 also may include identifying which of the strategic directions apply to each particular business function (441).

Sub-process 320 further includes developing functional strategies within each business function for achieving each of the core objectives and obligations (345; see also element 140 in FIGS. 1 and 2). The functional strategies are developed in light of the mission of each business function. Referring to FIGS. 4F-Q functional strategies for the business function of finance and controlling include (i) a functional strategy of reliable planning, as explained in FIG. 4F, for achieving the core objective of profitability, (ii) a functional strategy of improving liquidity for achieving the core objective of liquidity, (iii) a functional strategy of reliable financial reporting for achieving the core obligation of financial reporting, and (iv) a functional strategy of optimizing taxes for achieving the core obligation of tax management. As shown in FIG. 4G, implementations of sub-process 320 also may include defining a measure for each functional strategy (446).

Referring to FIG. 5A, operation 345 can be conceived of as, and implemented by, defining a potentially unique functional strategy for each cell of a matrix 510, where a set of matrix rows 512 are defined by the missions of the business functions and a set of matrix columns 514 are defined by the core requirements of the corporate strategy. The functional strategy of reliable planning occupies a cell 520 at the intersection of the mission of the finance and controlling business function and the profitability core objective. The functional strategy of improving liquidity occupies a cell 522 at the intersection of the mission of the finance and controlling business function and the liquidity core objective. The functional strategy of optimizing taxes occupies a cell 524 at the intersection of the mission of the finance and controlling business function and the tax management core obligation.

Implementations may analyze a corporate strategy or a corporation's strategic objective in a variety of ways, in addition to or in lieu of using missions of business functions and core requirements. The ways in which a corporate strategy or a corporation's strategic objective is analyzed may provide different information or a different breakdown, and such ways may be referred to as being independent of one another. Thus, implementations may employ the general approach of matrix 510 using different categories (other than missions of business functions and core requirements) to decompose a corporate strategy or a corporation's strategic objective.

Referring to FIG. 3C, a sub-process 355 may be carried out in one or more workshops with operational level management. Sub-process 355 begins with the result of operation 345 in which the functional strategies were developed and proceeds to separately analyze each of the functional strategies in two distinct ways. These two ways include defining critical enablers, also referred to as critical success factors, for achieving each functional strategy (360; see also element 160 in FIGS. 1 and 2), and defining tasks for achieving each functional strategy (365; see also element 150 in FIGS. 1 and 2). Tasks refer to activities. Critical enablers refer to objectives that result from a breakdown of the core objective under analysis (for which the functional strategy has been developed), as well as from an analysis of the goals that the tasks should achieve for accomplishing the given functional strategy.

Referring to FIGS. 4G-H, several examples are provided of critical enablers and tasks. As a first example, critical enablers for achieving the functional strategy of reliable planning include reliable assumptions, plan accountability, and performance tracking, whereas tasks for achieving the functional strategy of reliable planning include financial planning, revenue controlling, product cost controlling, overhead cost controlling, and investment controlling. As another example, critical enablers for achieving the functional strategy of improving liquidity include terms and conditions, and reliable forecasts, whereas tasks for achieving the functional strategy of improving liquidity include cash management, liquidity management, accounts receivable, local accounts payable, foreign accounts payable, and payroll.

The critical enablers for a given functional strategy can be seen to be a breakdown or decomposition of that given functional strategy reflecting particular aspects of that given functional strategy. Similarly, the tasks for a given functional strategy can be seen to be a breakdown or decomposition of that given functional strategy reflecting particular aspects of that given functional strategy.

Implementations may analyze and decompose a functional strategy in a variety of ways, in addition to or in lieu of using critical enablers and tasks. The ways in which a functional strategy is analyzed may provide different information or a different breakdown of the functional strategy, and such ways may be referred to as being independent of one another.

Sub-process 355 includes defining, for each task of each functional strategy, a set of operational strategies, also referred to as tactics, for achieving the critical enablers in each of the tasks (370; see also element 155 in FIGS. 1 and 2). Referring to FIG. 41, the implementation shows the operational strategies for the task of accounts receivable (within the functional strategy of improving liquidity, which is within the core objective of liquidity, and the overall strategic objective of increasing shareholder value). As shown in FIG. 41, the operational strategies include optimizing credit terms to achieve the critical enabler of terms and conditions, and forecasting receivables based on a customer's payment performance to achieve the critical enabler of reliable forecasts.

Referring to FIG. 5B, in a manner similar to operation 345 discussed above, operation 370 can be conceived of as, and implemented by, defining a potentially unique operational strategy for each cell of a matrix 540, where a set of matrix rows 542 are defined by the tasks of a functional strategy and a set of matrix columns 544 are defined by the critical enablers of the functional strategy. The operational strategy of optimizing credit terms occupies a cell 550 at the intersection of the accounts receivable task and the terms and conditions critical enabler. The operational strategy of forecasting receivables based on a customer's payment performance occupies a cell 552 at the intersection of the accounts receivable task and the reliable forecasts critical enabler. The cells of matrix 540 thus contain the operational strategies for achieving the functional strategy of improving liquidity.

Implementations may analyze a functional strategy in a variety of ways, in addition to or in lieu of using critical enablers and tasks. The ways in which a functional strategy is analyzed may provide different information or a different breakdown of the functional strategy, and such ways may be referred to as being independent of one another. Thus, implementations may employ the general approach of matrix 540 using different categories (other than critical enablers and tasks) to decompose a functional strategy.

As shown in FIG. 4I, an implementation also may include defining a mission of each task (468). Such a mission may then be used in defining the operational strategies associated with the task.

As further shown in FIG. 41, operational strategies for achieving the task of accounts receivable also may be defined with respect to any applicable core obligation. Specifically, FIG. 4I shows that operational strategies are defined for the task of accounts receivable in order to achieve the core obligations of financial reporting and risk management (472). Note that the operational strategies of operation 472 are presumptively in addition to the set of operational strategies that would be defined by matrices for the functional strategies for achieving each of the core obligations in the mission of the finance and controlling business function (for example, the functional strategy of optimizing taxes for achieving the core obligation of tax management, as shown in FIG. 4G and in cell 524 of FIG. 5A, would presumptively have its own matrix of operational strategies).

Operation 472 provides an explicit example of the interdependence of the operations in process 300 and of the ability of implementations of process 300 to use the data gathered in process 300 in non-linear and interdependent ways. More specifically, operation 472 applies the core obligations to each task of each functional strategy, even though the core obligations have already been applied in determining the functional strategies (see FIG. 5A).

Referring to FIGS. 4I-J, an implementation also may include (i) defining one or more measures for each of the operational strategies associated with a given task (473), (ii) allocating a strategic direction for each operational strategy (476), which also demonstrates the potential interdependence of the operations of process 300 and the data gathered in process 300, (iii) defining the human capital for each operational strategy (477), wherein the human capital refers to the body of knowledge in the form of skills or capabilities that the human resources of an organization have or should master for pursuing a given strategy, and (iv) defining the information capital for each operational strategy (479), wherein the informational capital is concerned with the body of strategic knowledge that the company should carefully manage in order to accomplish the company's overall enterprise strategy (note that the information capital is usually not visible for a company, but various implementations described herein make the information capital of a company visible).

Sub-process 355 includes defining, for each operational strategy of a given task, steps for achieving the operational strategy (375; see also element 165 in FIGS. 1 and 2). Referring to FIGS. 4J-K, steps are shown for achieving each of four operational strategies for the task of accounts receivable and the critical enabler of terms and conditions. As shown in FIG. 4J, the implementation includes the following five steps for achieving the operational strategy of reducing credit risk: establishing a credit policy, approving credit terms, enforcing credit limits, reviewing overdue accounts, and taking action on delinquent accounts.

Sub-process 355 further includes setting standards of cost, quality, and time for each step and assigning a responsible entity (380; see also element 170 in FIGS. 1 and 2). With respect to the standards, as with the definition of operational strategies, the setting of standards may be conceived of as, and implemented by, defining a potentially unique standard for each cell of a matrix, where the matrix rows are defined by the steps of an operational strategy and the matrix columns are defined by the categories of cost, quality, and time. Referring to FIG. 4L, an implementation shows the cost, quality, and time standards for the step of approving credit terms (380).

With respect to the responsible entity, a responsible entity may be, for example, a single individual, a group of individuals, or an organizational entity. By assigning a responsible entity, accountability is built into the strategy framework because the step has been assigned rather than merely being stated or defined. Further, the responsible entity may be provided an opportunity to provide input into the strategy during the workshop process, thereby providing a sense of ownership which further enhances accountability and implementation of the strategy.

FIG. 4L also shows that implementations may define a mission for each step (481). The mission may be used in defining the standards for that step.

Sub-process 355 further includes defining, for each step, (i) control objectives (step control objectives or “SCOs”) (385; see also element 227 in FIG. 2), controls based on the SCOs (390; see also element 237 in FIG. 2), and a process for implementing each step in accordance with the controls (395; see also element 217 in FIG. 2). Referring to FIGS. 4L-M, an implementation shows an SCO that includes (i) checking credit worthiness and (ii) defining payment terms and credit limits (380). The implementation further includes the controls of putting in place a process for checking credit worthiness, for evaluating securities, and for determining payment terms and credit limits according to a guideline (390). The implementation also includes a six-part process, as indicated in FIG. 4L, for achieving the step of approving credit terms (395).

FIGS. 4L-M also show that implementations may provide additional functionality. Such functionality may include defining documentation related to a step (482), defining images related to a step (483), defining a step's best practices (484), defining one or more tips for a step (485), defining technologies used in a step (486), and linking a step to a business process (487).

Implementations also may assign a responsible entity at various points in process 300 in addition to, or in lieu of, operation 385. For example, responsible entities may be assigned for one or more of the core objectives and obligations (314), business functions (340), functional strategies (345), and operational strategies (370). FIGS. 4D-K each indicate that a responsible entity is assigned to a particular item by using “person icon” 420 as shown in FIG. 4D. Further, measures may be defined for various operations in process 300, particularly where a responsible entity is assigned.

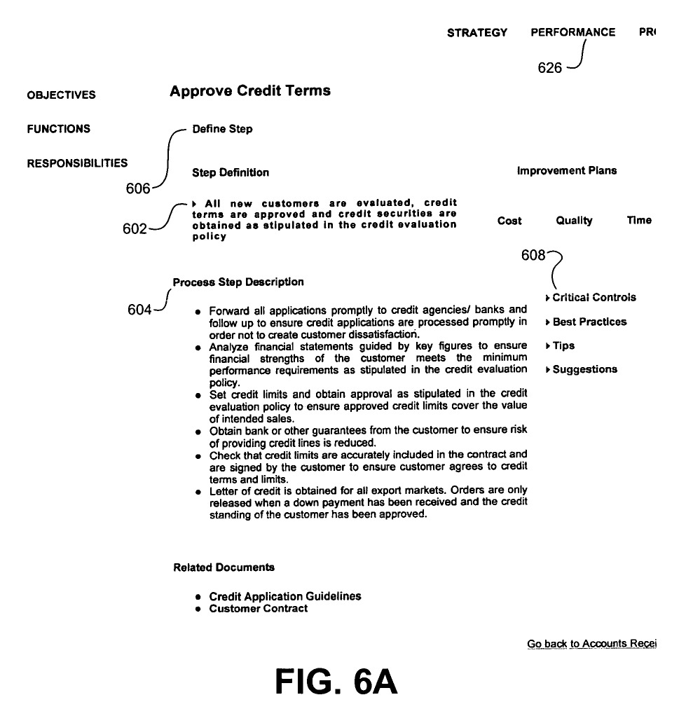

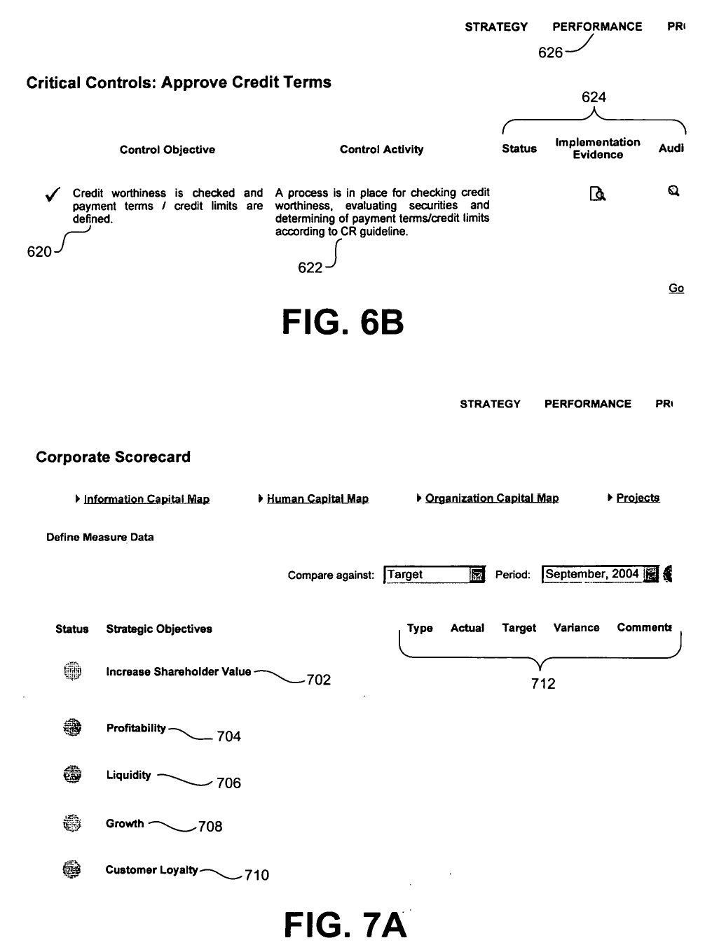

Referring to FIGS. 6A-B, two screen shots are provided that display some of the information that is entered on the screens depicted in FIGS. 4L-M. FIGS. 6A-B are screen shots from the front-end of the software tool, which is the interface that presents the collected strategy information. For example, FIG. 6A includes a step definition 602 that presents information entered in the field indicated by reference 481 in FIG. 4L, and a process description 604 that presents information entered in the field indicated by reference 395 in FIG. 4L. FIG. 6A also includes a step definition link 606 allowing permitted users to modify the collected information. After a user selects step definition link 606, the software tool leaves the front-end presentation and enters a back-end data entry portion which includes the screen shown in FIG. 4L.

FIG. 6A further includes various links, such as a critical controls link 608, that allow a user to pull up additional information. After a user selects critical controls link 608 in FIG. 6A, the software tool brings up the screen shot shown in FIG. 6B. FIG. 6B includes a control objective 620 that presents information entered in the field indicated by reference 385 in FIG. 4M, and a control activity 622 that presents information entered in the field indicated by reference 390 in FIG. 4M.

The front-end of the software tool also presents performance data. FIG. 6B includes various fields 624 that provide some indication of performance such as status. More particularly, however, FIGS. 6A-B each include a performance link 626 that links to a performance portion of the front-end that is tailored to presenting performance information.

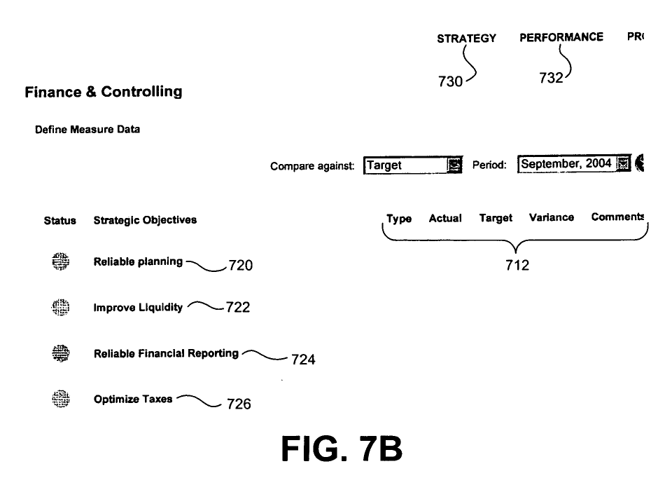

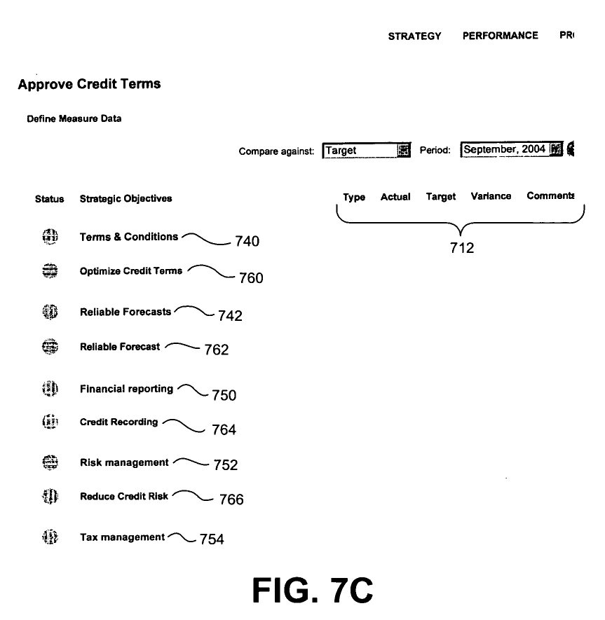

Referring to FIGS. 7A-C, three screen shots from the performance portion of the front-end are shown. The three screen shots may provide performance data on the implementation of the corporation's strategy, and provide this information in an increasingly detailed and specific view as described below. The performance portion may, thus, be accessed and entered by a user's selection of performance link 626. The provision of links such as performance link 626 and step definition link 606 allows a user to transition from viewing a corporation's strategy definition to monitoring performance in achieving the strategy and to redefining the strategy, respectively. As a result, a user may be able to adapt a corporation's strategy in real-time based on monitored performance results.

FIG. 7A presents a corporate scorecard that may include performance information on the strategic objective of increasing shareholder value 702, and on the core objectives of profitability 704, liquidity 706, growth 708, and customer loyalty 710. Recall that these objectives may be entered in the back-end of the software tool using the screens depicted in FIGS. 4B-C, and in particular using the fields indicated by references 312 and 314.

Performance (not shown) for each of these objectives 702-710 may be indicated under a set of categories 712. Performance data may be indicated using one or more of a variety of measures, such as those mentioned above in the discussion of operation 413 of FIG. 4B.

FIG. 7B depicts a screen shot that may provide performance data on the shared business function of finance and controlling. FIG. 7B is organized to provide performance data on each of the functional strategies defined for the business function of finance and controlling, including reliable planning 720, improving liquidity 722, reliable financial reporting 724, and optimizing taxes 726. Recall that the functional strategies 720-726 may be entered in the back-end of the software tool using the screens depicted in FIGS. 4F-G, and in particular using the field indicated by reference 345. FIG. 7B also includes a strategy link 730 that allows a user to link directly to the screen shot of FIG. 4F in the back-end of the software tool and allows, for example, the user to modify the functional strategies during a review of the performance data that may be provided in the screen shown in FIG. 7B. After modifying the functional strategies, the user may select a link 732, labeled in FIG. 7B but also occurring in FIG. 4F to transition back to the presentation of performance data in the front-end of the software tool.

FIG. 7C depicts a screen shot that may provide performance data on the step of approving credit terms, which is a step defined under the operational strategy of reducing credit risk. FIG. 7C lists three different categories of information. These categories include (i) the critical enablers 740 and 742 for the functional strategy of improving liquidity, (ii) the core obligations of the corporation 750, 752, and 754, and (iii) the four operational strategies for the task of accounts receivable 760, 762, 764, and 766. As with FIGS. 7A-7B, various performance measures 712 may be displayed for each of these listed categories 740, 742, 750, 752, 754, 760, 762, 764, and 766. Recall that information for these three categories may be entered in the back-end of the software tool using the screens depicted in FIGS. 4C, 4G, and 41, and in particular using the fields indicated by references 314, 360, 370, and 472.

A number of implementations have been described. Nevertheless, it will be understood that various modifications may be made. For example, elements of different implementations may be combined, supplemented, or removed to produce other implementations. Additionally, the described systems, methods, and techniques may be implemented, at least in part, in digital electronic circuitry, computer hardware, firmware, software, or in combinations of these elements, as shown, for example, in the software tool illustrated in various of the figures. Various implementations, such as, for example, the software tool illustrated in various figures, may be implemented as a computer program product including a program of instructions tangibly embodied in a machine-readable storage device for execution by one or more programmable processors. Such programmable processors may be distributed remotely or locally. Accordingly, other implementations are within the scope of the following claims.

What is claimed is:

1. A software-based tool for assisting an organization with corporate strategy, the tool comprising:
a first portion instructing a user to enter a strategy for a particular business function of an organization;
a second portion instructing the user to analyze the strategy in a first manner to produce a first set of categories related to achieving the strategy;
a third portion instructing the user to analyze the strategy in a second manner to produce a second set of categories related to achieving the strategy, the second set being independent of the first set; and
a fourth portion instructing the user to enter a set of sub-strategies including a different sub-strategy for each combination of categories in the first and second sets, each of the sub-strategies related to achieving a particular one of the combination of categories.

2. The tool of claim 1 wherein the first set of categories comprises qualitative goals and the second set of categories comprises tasks.

3. The tool of claim 1 further comprising a fifth portion instructing the user to enter (i) an identification of multiple business units of the organization, and (ii) a set of business functions of the organization, the set of business functions including core functions for each business unit and shared functions across business units, and the set of business functions including the particular business function.

4. The tool of claim 3 wherein the fifth portion instructs the user to enter an identification of all business units of the organization.

5. The tool of claim 1 further comprising a fifth portion instructing the user to enter a set of core requirements for the organization, the core requirements including one or more core obligations and one or more core objectives.

6. The tool of claim 1 further comprising:
a fifth portion instructing the user to enter one or more steps for implementing each sub-strategy, and measurable standards of performance for each step, the measurable standards including standards for a cost incurred to perform the step, a time incurred to perform the step, and a quality of performance of the step;
a sixth portion for comparing the measurable standards against actual performance data for each step and evaluating the performance data based on results of the comparing; and
a seventh portion for presenting results of the evaluating to the user, along with presenting the strategy information to the user.

7. The tool of claim 6 further comprising an eighth portion instructing the user to enter a responsible party for each of the steps, and wherein the seventh portion is configured to present the responsible party for each step for which performance data is evaluated and for a corporate level of the strategy, a functional level of the strategy, and an operational level of the strategy.

8. The tool of claim 6 wherein one or more of the first, fourth, and fifth portions is configured to allow the user to change all or part of the entered information after being presented the results of the evaluating.

9. A method of formulating corporate strategy for an organization, the method comprising:
determining a strategy for a particular business function of an organization;
analyzing the strategy in a first manner to produce a first set of categories related to achieving the strategy;
analyzing the strategy in a second manner to produce a second set of categories related to achieving the strategy, the second set being independent of the first set; and
determining a set of sub-strategies including a different sub-strategy for each combination of categories in the first and second sets, each of the sub-strategies related to achieving a particular one of the combination of categories.

10. The method of claim 9 wherein the first set of categories comprises qualitative goals and the second set of categories comprises tasks.

11. The method of claim 9 further comprising:
identifying multiple business units of the organization; and
identifying a set of business functions of the organization, the set of business functions including (i) core functions for each business unit and (ii) shared functions across business units, and the set of business functions including the particular business function.

12. The method of claim 11 wherein identifying multiple business units comprises identifying all business units of the organization.

13. The method of claim 9 further comprising determining a set of core requirements for the organization, the core requirements including one or more core obligations and one or more core objectives.

14. The method of claim 9 further comprising:
determining one or more steps for implementing each sub-strategy;
determining measurable standards of performance for each step, the measurable standards including standards for a cost incurred to perform the step, a time incurred to perform the step, and a quality of performance of the step;
comparing the measurable standards against actual performance data for each step;
evaluating the performance data based on results of the comparing;
presenting, to the user, results of the evaluating; and
presenting, to the user, strategy information including one or more of the strategy, the first set of categories, the second set of categories, and the set of sub-strategies.

15. The method of claim 14 further comprising determining measurable standards of performance for the strategy, the first set of categories, the second set of categories, and the set of sub-strategies.

16. The tool of claim 14 further comprising determining a responsible party for each of the steps, and wherein presenting the strategy information comprises presenting the responsible party for each step for which performance data is evaluated.

17. The tool of claim 14 further comprising the user changing one or more of the strategy, the first set of categories, the second set of categories, and the set of sub-strategies after the user is presented the results of the evaluating.

18. A method for formulating strategy for a corporation having multiple business units, the method using a strategy team to work with multiple layers of management to develop a strategy, the strategy team performing at least the following:
working with top level management of a corporation to determine core requirements including core obligations and core objectives;
working with top level management to determine multiple business units of the corporation;
working with functional level management to determine business functions including core functions for each business unit, and shared functions across multiple business units;
working with functional level management to determine missions for each business function;
working with functional level management to determine functional strategies for achieving each of the core requirements within each business function;
working with operational level management to determine critical enablers for each functional strategy, determining the critical enablers for any given functional strategy comprising analyzing the given functional strategy in a first manner to produce the critical enablers related to achieving the given functional strategy;
working with operational level management to determine tasks for each functional strategy, determining the tasks for any given functional strategy comprising analyzing the given functional strategy in a second manner to produce the tasks related to achieving the given functional strategy, the tasks and critical enablers related to achieving the given functional strategy being independent of each other; and
working with operational level management to determine operational strategies for each functional strategy, the operational strategies for any given functional strategy including a different operational strategy for each combination of critical enabler and task related to achieving the given functional strategy, and each of the different operational strategies being related to achieving a particular one of the critical enablers and a particular one of the tasks that form the combination.

19. The method of claim 18 further comprising working with operational level management to determine steps for implementing each operational strategy, and to determine measurable standards for cost, quality, and time for each step.

20. The method of claim 19 further comprising assigning a responsible entity for each step.

21. The method of claim 18 further comprising:
working with top level management to perform an analysis of the corporation's strengths, weaknesses, opportunities, and threats (“SWOT”); and
working with top level management to apply results of the SWOT analysis to determine strategic direction and strategic objectives, wherein working with top level management to determine the core requirements includes determining the core requirements based on the strategic direction and the strategic objectives.

22. The method of claim 18 further comprising using a software tool to capture information.
